(19) United States
(12) Patent Application Publication
(10) Pub. No.: US 2023/0311261 A1
(43) Pub. Date: Oct. 5, 2023

(54) PARTICULATE CAPTURE METHODS, DEVICES AND SYSTEMS FOR ROTARY MACHINE TOOLS

(71) Applicant: SCOTT BENNETT, BROOKLIN (CA)

(72) Inventor: SCOTT BENNETT, BROOKLIN (CA)

(21) Appl. No.: 18/194,828

(22) Filed: Apr. 3, 2023

Related U.S. Application Data
(60) Provisional application No. 63/326,998, filed on Apr. 4, 2022.

(51) Int. Cl. B23Q 11/00; B23B 25/00

(52) U.S. Cl. CPC B23Q 11/005; B23B 25/00

(57) ABSTRACT

Multiple uses of lathes exist where a cutting or scraping tool is initially employed to remove material generating particulates with a range of sizes from shavings and chippings to fine dust. Subsequently, sanding to smooth the surface of all or parts of the piece to the desired smoothness generates particulates with a size range dependent upon the abrasive used but are typically small in dimension and commonly referred to as dust. Without any control of this removed material it creates a mess and a health hazard particularly for the lathe operator and others in the vicinity from aspiration of the dust. Accordingly, it would be beneficial to provide lathe operators, enterprises employing lathe operators, etc. with a system that provides for removal of the chippings, shavings, and dust whilst allowing the user to employ the shaping tools and abrasives to achieve the desired result.

This patent application claims the benefit of priority from U.S. Provisional Patent Application 63/326,998 filed Apr. 4, 2022; the entire contents of which are incorporated herein by reference.

### FIELD OF THE INVENTION

This patent application relates to particulate collection systems and more particularly to particulate collection systems for lathes.

### BACKGROUND OF THE INVENTION

Amongst the multiple uses of lathes woodturning is perhaps the oldest although the principles are common to turning metal, plastics, etc. to shape the internal and external profiles of a block of material. In use a cutting or scraping tool is initially employed to remove material as the piece being turned rotates this generating particulates with a range of sizes from shavings and chippings to fine dust. Subsequently, sanding typically employs the application of one or more abrasive such as glass paper, for example, to smooth the surface of all or parts of the piece to the desired smoothness. This sanding typically generates particulates with a size range dependent upon the abrasive used but are typically small in dimension and commonly referred to as dust.

The result is that the removed material from the initial material is distributed around the work area, or beyond in the instance of dust, as it is removed thereby creating a mess which must be cleared up, i.e. the chippings, shavings, and dust, but also a health hazard particularly for the lathe operator and others in the vicinity from aspiration of the dust.

Accordingly, it would be beneficial to provide lathe operators, enterprises employing lathe operators, etc. with a system that provides for removal of the chippings, shavings, and dust whilst allowing the user to employ the shaping tools and abrasives to achieve the desired result.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to particulate collection systems and more particularly to particulate collection systems for lathes.

This invention captures particulate close to the source therefore preventing most of the particulates from contaminating the workspace and the air

In accordance with an embodiment of the invention there is provided a method of capturing particulates comprising:
deploying a particulate capture system (PCS) with respect to a lathe; and
capturing particulates of a material removed from a piece-part upon the lathe; wherein
   the PCS comprises:
   an exhaust portion for coupling to an exhaust system;
   a fixed portion coupled to the exhaust portion; and
   a movable portion coupled to the fixed portion at a first end and having an opening at a second distal end; and
an airflow through the opening induced by the exhaust system transports the particulates of the material that are either within the vicinity of the opening external to the movable portion or within the movable portion to the exhaust portion to the exhaust portion.

In accordance with another embodiment of the invention there is provided a particulate capture system for use with a lathe comprising:
an exhaust portion for coupling to an exhaust system;
a fixed portion coupled to the exhaust portion; and
a movable portion coupled to the fixed portion at a first end and having an opening at a second distal end; wherein
an air-flow through the opening induced by the exhaust system transports the particulates of the material that are either within the vicinity of the opening external to the movable portion or within the movable portion to the exhaust portion to the exhaust portion.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a lathe with a particulate capture system according to an embodiment of the invention prior to use;

FIG. 2 depicts the lathe with the particulate capture system according to an embodiment of the invention during use with a shaping tool;

FIG. 3 depicts the lathe with the particulate capture system according to an embodiment of the invention with a hinged portion in raised position;

FIG. 4 depicts a lathe with a particulate capture system according to an embodiment of the invention prior to use;

FIG. 5 depicts the lathe with the particulate capture system according to an embodiment of the invention during use with an abrasive generating dust;

FIG. 6 depicts a particulate capture system according to an embodiment of the invention;

FIG. 7 depicts the particulate capture system according to an embodiment of the invention in FIG. 6 mounted to a positioning system;

FIG. 8 depicts a particulate capture system according to an embodiment of the invention with a second lower particulate capture system according to an embodiment of the invention.

### DETAILED DESCRIPTION

The present invention is directed to particulate collection systems and more particularly to particulate collection systems for lathes.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “lathe” as used herein and throughout this disclosure, refers to a machine tool that rotates a workpiece about an axis of rotation to perform various operations such as cutting, sanding, knurling, drilling, deformation, facing, and turning, with tools that are applied to the workpiece to create an object with symmetry about that axis. Lathes are used in woodturning, metalworking, metal spinning, stone turning, thermal spraying, parts reclamation, and glass-working.

A “fitting” as used herein and throughout this disclosure, refers to any machine component, piping or tubing part that can attach or connect two or more parts. Such fittings may include, but not be limited to, a coupling, couplings, compression fitting, pipe fitting, piping fittings, plumbing fittings, and plumbing fitting.

A “mounting” as used herein and throughout this disclosure, refers to part of a device, system., ancillary, etc. which is configured to support and/or attach another device, system, ancillary, components etc. to said part of the device, system, ancillary, component etc. A mounting typically supports demountable attachment of the parts but may be employed in permanent attachment to define the location of the point of attachment or support demountable attachment prior to permanent attachment.

A “fixing” or “attachment means” as used herein and throughout this disclosure, refers to component, device, or means employed to permanently or demountably attach a device, system, ancillary, components etc. to part of another device, system, ancillary, component etc. This may include, but not be limited to, depending upon whether permanent or demountable and the material(s) being joined fasteners, glues, resins, epoxies, cementing, welding, soldering, brazing, pressure differentials, magnets, clamps, clips, ties, supports, physical retention elements such as clips and crimps, and physical retention methods such as friction and interference fit. Fasteners may include, but not be limited to, bolts, nuts, washers, screws, threaded fasteners, rivets, nails, pins, hook-and-eye, and hook and loop.

A “demountable” connection as used herein and throughout this disclosure, refers to component, device, or means employed to permanently or demountably attach an electrical connection or fluidic connection on a device, system, ancillary, components etc. to another electrical connection or fluidic connection on another device, system, ancillary, component etc. Fluidic “demountable” connections typically are formed by male-female threaded connectors with O-ring, sealing ring or gasket seals.

A “fluid” as used herein refers to a liquid, a gas, a mixture of liquids or a mixture of gases. Whilst a lathe may typically be employed in air without any liquid it would be evident that within other instances employing embodiments of the invention that a liquid or combination of liquids may be employed in conjunction with the shaping tool or abrasive. Such liquid or liquids providing, for example, lubrication or cooling. It would also be evident that within other instances employing embodiments of the invention that a gas or gases may be employed in addition to air or to provide an environment around the shaping tool or abrasive which is, for example, one with lower oxygen content.

Amongst the multiple uses of lathes woodturning is perhaps the oldest although the principles are common to turning metal, plastics, etc. to generate a circularly symmetric or asymmetric piece from an initial block of material.

Whilst the following description and figures depict a lathe being employed to turn a horizontally piece of wood it would be evident that embodiments of the invention may be applied to other materials including, but not limited to, laminated wood, a metal, an alloy, a plastic, glass, stone, clay and ceramic.

Whilst the following description and figures depict a lathe being employed to turn a horizontally disposed piece-part with tools that moved horizontally along the piece-part it would be evident that embodiments of the invention may be applied to lathes where the piece-part is vertical or inclined with respect to the horizontal and vertical planes. It would also be evident that embodiments of the invention may be applied to lathes where the tool is vertically disposed/moved with respect to the piece-part or is orientated at angles to both the horizontal and vertical planes independent of the orientation of the lathe and/or the piece-part.

In use a shaping tool is initially employed to remove material as the piece being turned rotates this generating particulates with a range of sizes but typically larger in dimension and commonly referred to as shavings or chippings (or swarf with metallic debris). Subsequently, sanding typically employs the application of one or more abrasives such as glass paper, for example, to smooth the surface of all or parts of the piece to the desired smoothness. This sanding typically generates particulates with a size range dependent upon the abrasive used but are typically small in dimension and commonly referred to as dust. The shaping process also generates dust.

The result is that the removed material from the initial material is distributed around the work area, or beyond in the instance of dust, as it is removed thereby creating a mess which must be cleared up, i.e. the chippings, shavings, and dust, but also a health hazard particularly for the lathe operator and others in the vicinity from aspiration of the dust.

The US Occupational Safety and Health Administration (OSHA) recommended solution for lathe dust collection is an open-faced hood attached to a movable mechanical arm at the point of operation. However, prior art solutions to provide this are limited in their effectiveness as they are not designed to form part of the overall work environment for the user with consideration of the lathe structure, the user's position and the tool's position and are removed from the actual point of particulate generation. Accordingly, embodiments of the invention provide a solution that works more effectively than the OSHA recommended solution lower particulates and thereby reducing issues over health hazards and work area cleanliness.

It is widely accepted that the best practice for wood dust collection is to collect dust at the source. For example, the OSHA states that “wood dust is emitted at high velocity by moving or spinning machine components. The primary method of controlling wood dust is with local exhaust ventilation (LEV), which removes dust at or near its source . . . . Exhaust hoods should be located as close as possible to the emission source, either on the woodworking machinery itself or near to the machine. The local exhaust systems should have an efficient air cleaning device.”

Accordingly, it would be beneficial to provide lathe operators, enterprises employing lathe operators, etc. with a system that provides for removal of the chippings, shavings, and dust whilst allowing the user to employ the shaping tools and abrasives to achieve the desired result.

A lathe typically comprises a bed, a headstock and a tailstock. Some specialized lathes such as for turning large bowls may not have the bed or tail stock but do comprise the headstock and often a cantilevered tool rest. The bed is typically a horizontal beam although it may within other instances be an inclined or vertical beam. At one end of the bed is disposed the headstock which contains precision spinning bearings within which is rotating a horizontal axle, more specifically along an axis parallel to the bed, commonly called the spindle. The spindle is coupled directly or indirectly to a source of rotary motion such that the spindle rotates. Spindles are powered and impart motion to the workpiece. The source of motion may for example be a foot pedal or treadle and flywheel or by a belt or gear drive from a power source such as electric motor or overhead line shafts.

The counterpoint to the headstock is the tailstock, sometimes referred to as the loose head, as it can be positioned at any convenient point on the bed by sliding it to the desired position. The tail-stock contains a barrel, which does not rotate, but can slide in and out parallel to the axis of the bed and directly in line with the headstock spindle. The part to be turned is positioned between the tailstock and headstock.

The lathe may further comprise a carriage topped with a cross-slide that can be moved along the bed. The cross-slide may support a compound rest providing additional axes of motion, rotary and linear, and thereupon a tool-post which holds a shaping tool. Other lathes may not employ a cross-slide but other means to move and support a tool-post and a tool-rest so that the turner may employ a shaping tool which is braced against the tool rest and levered into the workpiece.

After shaping sanding may be performed using a sheet such as glass paper (which comprises crystalline silica (SiO2)), emery paper (which comprises crystalline aluminum oxide (Al2O3)) or a sheet with another material such as silicon carbide (SiC) to smooth the surface made with the, typically metal or SiC tipped metal, shaping tools. During this the tool rest is typically removed as it may be unsafe to have the operators hands between the fixed tool-rest and spinning wood.

Accordingly, the inventor has established a particulate capture system which within embodiments of the invention which is configured to support particulate capture during both shaping and sanding. Accordingly, embodiments of the invention provide for removal of the chippings, shavings, swarf and dust whilst allowing the user to employ the shaping tools and sanding to achieve the desired result.

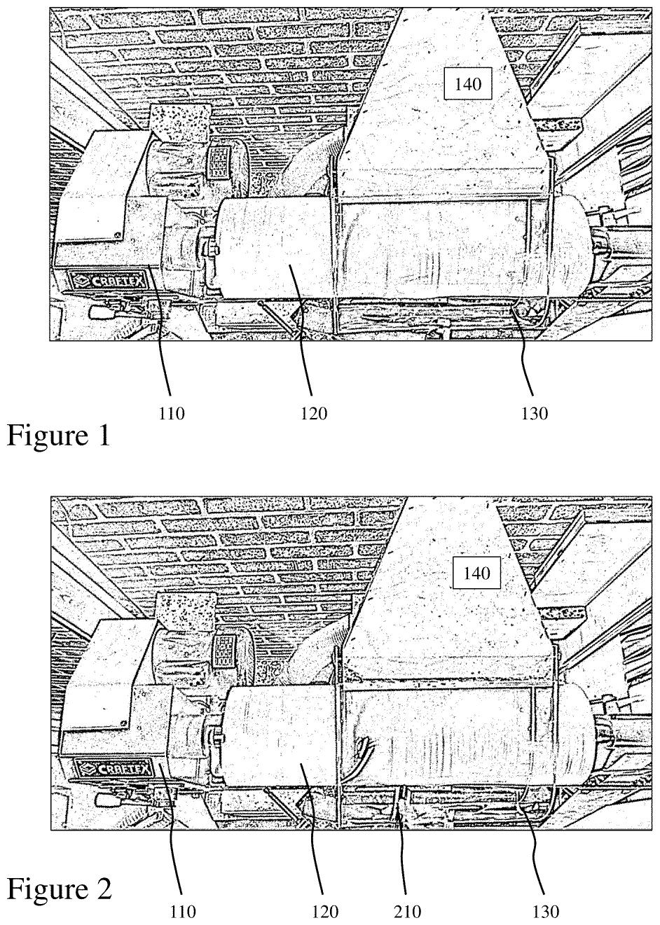

Referring to FIG. 1 there is depicted a lathe with a particulate capture system according to an embodiment of the invention prior to use. Accordingly, there is depicted a Lathe 110 with a Work-Piece 120 mounted upon it and held by the headstock and tailstock (not identified discretely but to the left and right of the Work-Piece 120 respectively). Also depicted are a Capture Hood 130 and Exhaust 140. As evident from the description below the Capture Hood 130 is fluidically coupled to the Exhaust 140 such that chippings, shavings, swarf and dust captured by the Capture Hood 130 are removed through the Exhaust 140.

The Exhaust 140 is connected to an external system via a fixed fitting, a fixed connection, a demountable fitting, or a demountable connection. This external system provides a flow of air from the Exhaust 140 (and therein from the Capture Hood 130 and its immediate vicinity) to the external system through one or more collection mechanisms to separate the extracted chippings, shavings, swarf and dust from the air. These mechanisms including porous bags, centrifugal separation, cyclonic separation, etc., are referred to as dust collection systems. The external system may include a blast gate to control air flow and may be turned on-off independent of the lathe or automatically from the lathe or an intermediate switch box.

Accordingly, the air flow into and through the Capture Hood 130 induced by the external system pulls the chippings, shavings, swarf and dust (hereinafter particulates) initially into the Capture Hood 130 and thereafter into the Exhaust 140.

Now referring to FIG. 2 there is depicted the Lathe 110 with the particulate capture system according to an embodiment of the invention during use with a Shaping Tool 210. As such the Shaping Tool 210 removes material from the Piece-Part 120 wherein the particulates are pulled under the action of the external system into the Capture Hood 130 and thereafter into the Exhaust 140. The width of the Capture Hood 130 may be less than the length of the bed of the Lathe 110 where the Capture Hood 130 may be moved along the bed of the Lathe 110 although within other embodiments of the invention the width of the Capture Hood 130 may be equal to or larger than the length of the bed of the Lathe 110.

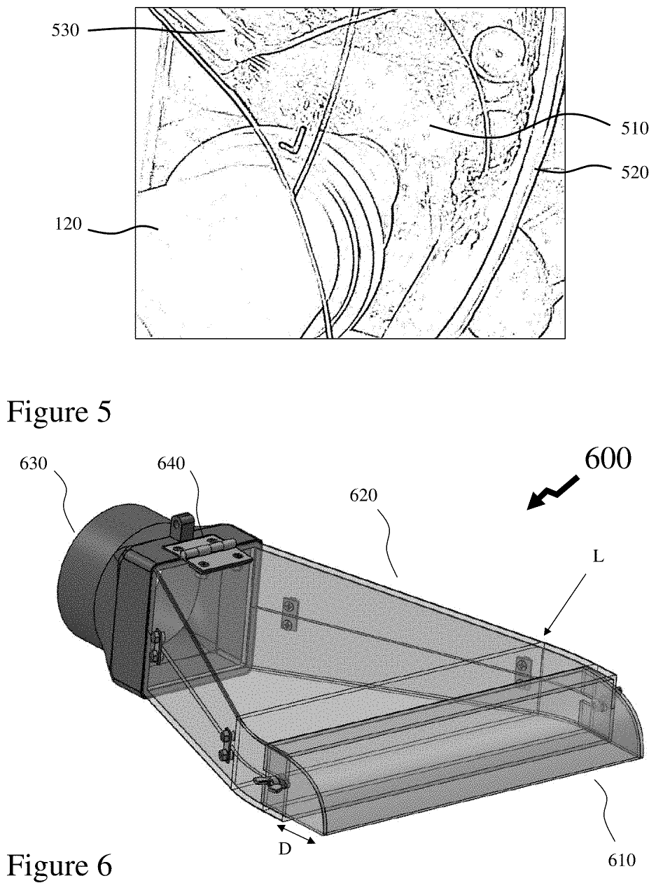

The depth of the Capture Hood 130/Exhaust 140 relative to the Piece-Part 120 may also vary from that depicted in FIGS. 1 and 2. The inventor has established that an important aspect of the Capture Hood 130 is a distance between and end of lower portion of the Capture Hood 130 and the inner surface of the upper portion of the Capture Hood 130 that extends over and down so that the external system can provide sufficient air-flow to capture and remove the particulates. This will become more evident from FIGS. 5 and 6. Accordingly, whilst the design depicted in FIGS. 1 to 4 has a fixed geometry of the Capture Hood 130 and Exhaust 140 it would be evident from FIG. 5 and variants thereof that an adjustable Capture Hood 130 may be employed allowing the dimension of this distance to be varied or the positioning of this opening relative to the Piece-Part 120 to be varied without moving the entire particulate capture system.

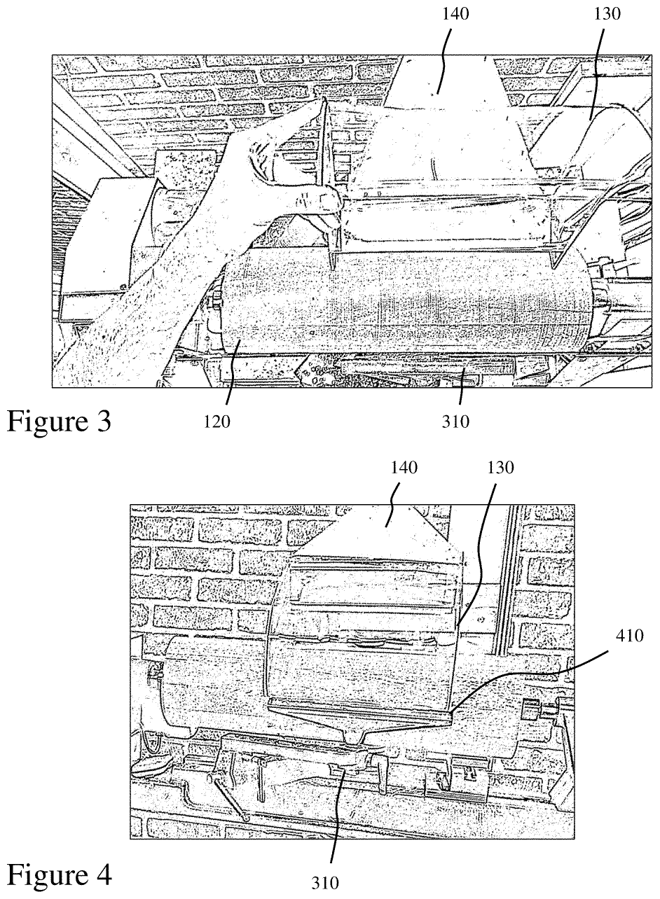

Referring to FIG. 3 there is depicted a Lathe 100 with the particulate capture system according to an embodiment of the invention with the Capture Hood 130 attached via one or more hinges to the Exhaust 140 so that the Capture Hood 130 can be placed into the raised position as depicted in FIG. 3 or a lowered position as depicted in FIGS. 1 and 2. In this manner, the particulate capture system allows for insertion/removal of the Piece-Part 120 without movement of the entire particulate capture system away from the Lathe 110. Also depicted at the bottom of FIG. 3 is a Tool-Rest 310.

Within other embodiments of the invention the Capture Hood 130 may be fixed to Exhaust 140 which itself has a hinged connected to the external system wherein both the Capture Hood 130 and Exhaust 140 can be raised/lowered for insertion/removal of the Piece-Part 120 without movement of the entire particulate capture system away from the Lathe 110.

Now referring to FIG. 4 there is depicted a lathe with a particulate capture system according to an embodiment of the invention prior to use. Accordingly, there are shown the Tool-Rest 310, Capture Hood 130 and Exhaust 140 where the Capture Hood 130 now includes a Handle 410 for eased listing/lowering by the user.

Referring to FIG. 5 there is depicted a lathe with the particulate capture system according to an embodiment of the invention during use with an abrasive generating dust. Accordingly, there are depicted the Piece-Part 120, a Lower Portion 530 of the Capture Hood 130 and an Upper Portion 520 of the Capture Hood 130. Accordingly, the gap between the Lower Portion 530 of the Capture Hood 130 and the Upper Portion 520 of the Capture Hood 130 is the region wherein the airflow induced by the external system pulls particulates into the particulate capture system or particulates physically moved into the Capture Hood 130 during use of a shaping tool or abrasive are removed. Within FIG. 5 the user is employing glass paper upon a wood Piece-Part 120 generating dust particles that evident as Dust Stream 510 being pulled into and up within the Capture Hood 130.

Now referring to FIG. 6 there is depicted a particulate capture system (PCS) 600 according to an embodiment of the invention. The PCS 600 providing the equivalent elements as the Capture Hood 130 and Exhaust 140. As depicted the PCS 600 comprises Exhaust Portion 630, a Fixed Capture Portion 620, a Movable Capture Portion 610 and a Hinge 640. Accordingly, the Hinge 640 allows the Fixed Capture Portion 620 and Movable Capture Portion 610 to be raised/lowered as described above to allow insertion/removal of the piece-part, e.g. Piece-Part 120.

The adjustable mounting of the Movable Capture Portion 610 allows for adjustment of the distance between the lower edge of the Fixed Capture Portion 620 and the Movable Capture Portion 610. Alternatively, within another embodiment of the invention the Movable Capture Portion 610 is attached to the Fixed Capture Portion 620 in a single position or in one of a number of predetermined positions.

Accordingly, the PCS 600 comprises for the Fixed Capture Portion 620 a base, a top and a pair of sides where these transition from a first geometry at the interface to the Exhaust Portion 630 to a second geometry compatible with a first end of the Movable Capture Portion 610 fitting within it. The second end of the Movable Capture Portion 610 being defined by the arcurate end of the Movable Capture Portion 610. Whilst this arcurate end is depicted as a smooth curved it may alternatively be formed from a piece-wise or stepwise approximation. The dimension D is therefore defined by the inner surface of the arcurate end of the Movable Capture Portion 610 and the edge of the Fixed Capture Portion 620.

Within other embodiments of the invention the hinged joint may be disposed at another location, e.g. location L, or another point.

It would be evident that the design depicted in FIG. 6 for the PCS 600 reflects a design for the Fixed Capture Portion with upper and lower portions mechanically connected by fittings. However, it would be evident that such portions may be glued, welded etc. depending upon the materials employed or that it may be formed as a single part.

Optionally, the Movable Capture Portion 610 may include a slot allowing for the insertion of a tool through it to work the piece-part.

Optionally, the front of the Movable Capture Portion 610 may extend down below the level of the Fixed Capture Portion 620 and include a slot allowing for the insertion of a tool through it to work the piece-part.

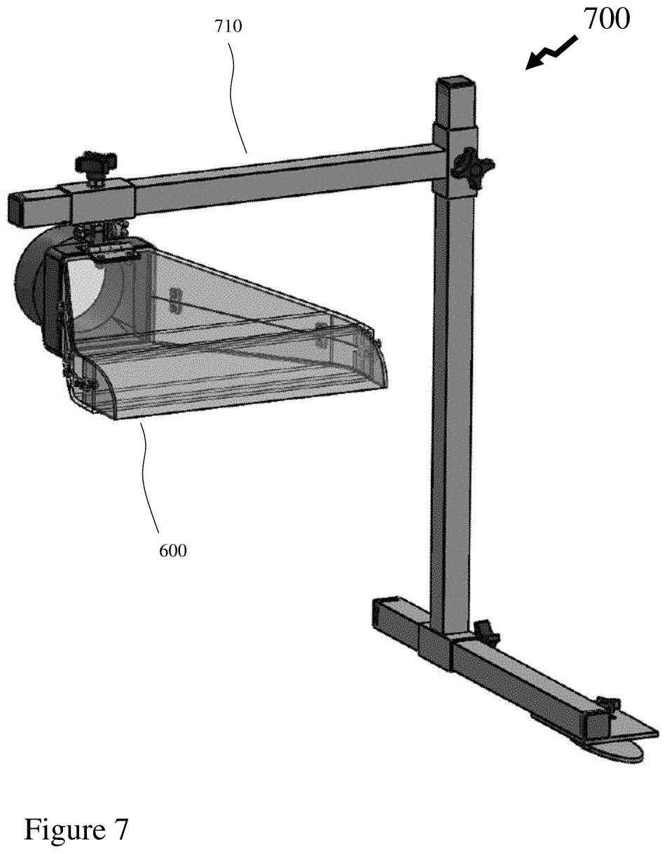

Referring to FIG. 7 there is depicted an Assembly 700 comprising a PCS 600 or other particulate capture system according to an embodiment of the invention mounted to a Positioning System 710 which allows for the position of the PCS 600 to be adjusted relative to the lathe and its work-piece, which are not depicted. Accordingly, the PCS 600, which in this instance may have a width less than the length of the beam of the lathe can be moved along the length of the work-piece to the appropriate position whilst its height may be adjusted to account for different diameters of the work-piece either initially or during its shaping/sanding.

Within other embodiments of the invention the Positioning System 710 may be motorized on one or both axes or it may employ one or more cantilevers etc.

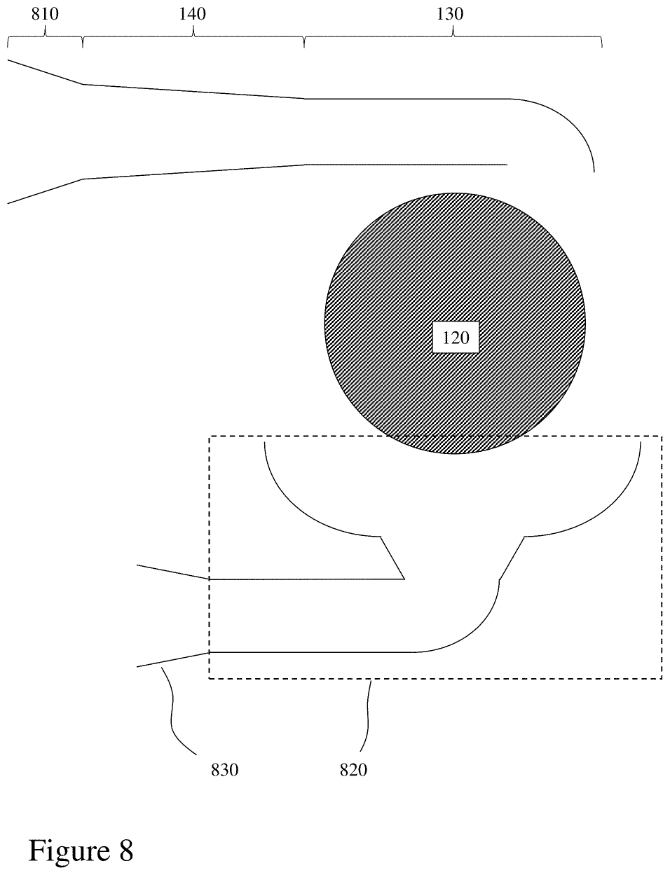

Whilst the embodiments of the invention are intended to capture particulates as they are generated by placing the opening within the particulate capture system within the vicinity of the piece-part where the tool is being applied it would be evident that such systems are unlikely to achieve 100% efficiency. Accordingly, within other embodiments of the invention one or more other elements may be disposed below the piece-part and/or the beam to capture. For example, referring to FIG. 8 there is depicted a particulate capture system according to an embodiment of the invention with a second lower particulate capture system according to an embodiment of the invention.

As depicted an upper particulate capture system such as described and depicted in FIGS. 1-6 comprising Capture Hood 130 and Exhaust 140 which is connected to a first Port 810 of an external system. Disposed below the Piece-Part 120 is a Capture Element 820 which is coupled to a second Port 830. Accordingly, particulates are also captured below the Piece-Part 120. The Capture Element 820 representing another particulate capture system employed with a particulate capture system, Capture Hood 130. The Capture Element 820 comprising another exhaust portion (Port 830) for coupling to the exhaust system and another fixed portion coupled to the exhaust portion. However, within another embodiment of the invention the Capture Element 820 may comprise a fixed portion coupled to the another exhaust portion and another movable portion which is coupled to the another fixed portion at a first end and having an opening at a second distal end. The opening at the second distal end may be moveable at least one of in a first direction and a second direction with respect to the piece-part where the first direction and the second direction are mutually orthogonal and orthogonal to an axis of the lathe along which the piece-part rotates under action of the lathe. The first direction being, for example, vertically towards or away from the Piece-Part 120 and the second direction being, for example, towards or away from an operator of the lathe.

Within the preceding description of embodiments of the invention the piece-part being shaped is an elongated part having a longitudinal length larger than its lateral dimension. However, it would be evident that within other embodiments of the invention the part being worked upon may have a longitudinal length less than its lateral dimension such as when turning a bowl, for example, where both an inner surface of the final product and an outer surface of the final product are shaped and finished.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of capturing particulates comprising:
deploying a particulate capture system with respect to a lathe; and
capturing particulates of a material removed from a piece-part upon the lathe; wherein
the particulate capture system comprises:
an exhaust portion for coupling to an exhaust system;
a fixed portion coupled to the exhaust portion; and
a movable portion coupled to the fixed portion at a first end and having an opening at a second distal end; and
an airflow through the opening induced by the exhaust system transports the particulates of the material that are either within the vicinity of the opening external to the movable portion or within the movable portion to the exhaust portion to the exhaust portion.

2. The method according to claim 1, wherein
the movable portion is coupled to the fixed portion by a hinge allowing the movable portion to pivot relative to the fixed portion;
in a lowered position the movable portion is disposed towards the piece-part; and
in a raised position the movable portion allows insertion or removal of the piece-part.

3. The method according to claim 1, wherein
a first portion of the movable portion can be moved relative to a second portion of the movable portion to adjust a dimension of the opening along an axis from first end to the second distal end;
the movable portion is coupled to the fixed portion by a hinge allowing the movable portion to pivot relative to the fixed portion;
in a lowered position the movable portion is disposed towards the piece-part; and
in a raised position the movable portion allows insertion or removal of the piece-part.

4. The method according to claim 1, wherein
the second distal end of the movable portion includes a second opening allowing insertion of a tool through the second opening to engage the piece-part for either shaping the piece-part or sanding the piece-part.

5. The method according to claim 1, wherein
the piece-part is either an elongate part having a longitudinal length larger than its lateral dimension or a part having a longitudinal length less than its lateral dimension.

6. The method according to claim 1, further comprising
deploying another particulate capture system with respect to the lathe for capturing other particulates of the material removed from the piece-part upon the lathe; wherein
the another particulate capture system comprises:
another exhaust portion for coupling to the exhaust system; and
another fixed portion coupled to the exhaust portion;
the another particulate capture system is disposed beneath the piece-part and the particulate capture system is disposed above the piece-part; and
an airflow through the opening induced by the exhaust system transports the particulates of the material that are either within the vicinity of the opening external to the movable portion or within the movable portion to the exhaust portion to the exhaust portion.

7. The method according to claim 6, further comprising
another movable portion which is coupled to the another fixed portion at a first end and having an opening at a second distal end; wherein
the opening at the second distal end can be moved at least one of in a first direction and a second direction with respect to the piece-part; and
the first direction and the second direction are mutually orthogonal and orthogonal to an axis of the lathe along which the piece-part rotates under action of the lathe.

8. A particulate capture system for use with a lathe comprising:
an exhaust portion for coupling to an exhaust system;
a fixed portion coupled to the exhaust portion; and
a movable portion coupled to the fixed portion at a first end and having an opening at a second distal end; wherein
an airflow through the opening induced by the exhaust system transports the particulates of the material that are either within the vicinity of the opening external to the movable portion or within the movable portion to the exhaust portion to the exhaust portion.

9. The particulate capture system according to claim 8, wherein
the movable portion is coupled to the fixed portion by a hinge allowing the movable portion to pivot relative to the fixed portion;
in a lowered position the movable portion is disposed towards the piece-part; and
in a raised position the movable portion allows insertion or removal of the piece-part.

10. The particulate capture system according to claim 8, wherein
a first portion of the movable portion can be moved relative to a second portion of the movable portion to adjust a dimension of the opening along an axis from first end to the second distal end;
the movable portion is coupled to the fixed portion by a hinge allowing the movable portion to pivot relative to the fixed portion;
in a lowered position the movable portion is disposed towards the piece-part; and
in a raised position the movable portion allows insertion or removal of the piece-part.

11. The particulate capture system according to claim 8, wherein
the second distal end of the movable portion includes a second opening allowing insertion of a tool through the second opening to engage the piece-part for either shaping the piece-part or sanding the piece-part.

12. The particulate capture system according to claim 8, wherein
the piece-part is either an elongate part having a longitudinal length larger than its lateral dimension or a part having a longitudinal length less than its lateral dimension.

13. The particulate capture system according to claim 8, further comprising
another particulate capture system disposed with respect to the lathe for capturing other particulates of the material removed from the piece-part upon the lathe; wherein
the another particulate capture system comprises:
another exhaust portion for coupling to the exhaust system; and
another fixed portion coupled to the exhaust portion;
the another particulate capture system is disposed beneath the piece-part and the particulate capture system is disposed above the piece-part; and
an airflow through the opening induced by the exhaust system transports the particulates of the material that are either within the vicinity of the opening external to the movable portion or within the movable portion to the exhaust portion to the exhaust portion.

14. The particulate capture system according to claim 13, further comprising
another movable portion which is coupled to the another fixed portion at a first end and having an opening at a second distal end; wherein
the opening at the second distal end can be moved at least one of in a first direction and a second direction with respect to the piece-part; and
the first direction and the second direction are mutually orthogonal and orthogonal to an axis of the lathe along which the piece-part rotates under action of the lathe.
